(19) United States
(12) Patent Application Publication
(10) Pub. No.: US 2006/0112022 A1
(43) Pub. Date: May 25, 2006

(54) Method of preparing a service agreement

(75) Inventors: Joachim Andres, Grossenseebach (DE); Thomas Heimke, Erlangen (DE); Andreas Kuss, Berlin (DE); Peter Schmitt, Baar (CH); Steffen Wagner, Stutensee (DE)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 10/984,635

(22) Filed: Nov. 9, 2004

(51) Int. Cl. G06F 17/00

(52) U.S. Cl. 705/400

(57) ABSTRACT

The present invention provides an efficient and simple method of preparing a product quote for a customer operating a technical installation. The product quote is based on a data set acquired during the operation of the installation, a product chosen for use with the installation and a customer benefit related to the chosen product and the data set.

### FIELD OF THE INVENTION

The present invention relates to a method of preparing a service agreement.

### BACKGROUND OF THE INVENTION

For many customers purchasing sophisticated technical equipment like production machinery, industrial plants, turbines, generators, passenger trains, vehicles, home entertainment devices and many more, an important aspect of their purchase decision is the availability of a reliable, efficient and cost-effective after-sales service. Modern technology often requires highly specialized and educated service providers. So more and more manufacturers put much effort in offering after-sales services and many independent service providers are competing with them.

When a customer's technical equipment needs service, he or she usually gets quotes from more than one service provider and chooses the best offer. As there are many sources of information available, for example using the internet to gather service information, worldwide or calling a plurality of service providers, it often pays off to compare several offers before making a decision on closing a service agreement with a special provider.

### SUMMARY OF THE INVENTION

Known quotes for service agreements are prepared when a prospective customer contacts a plurality of service providers and asks for quotes. Usually, the service providers choose appropriate services of their service range based on the customer's requirements and calculate corresponding fees.

The scopes and the fees of offered services are hardly ever identical, the cheapest offer may not be the best and so may not be the most expensive. It is completely up to the customer to judge the different alternatives and how he benefits from each.

It is therefore an object of the invention to provide a simple and effective method of preparing a high-quality service agreement for a customer which supports his decision making.

One aspect of the invention thus involves a concept of proving a set of service options based on a customer's service requirements.

The set of service options reflects the pool from which the service agreement is selected by choosing a plurality of options (first subset) from the set of options.

A further aspect of the invention includes selecting a second subset of service actions from the set of service options, the second subset reflecting an alternative to the first subset, but still meeting the customer's service requirements.

Another aspect of the invention relates to calculating service fees related to the first and second subsets. This fees represent the offer price for each subset.

Yet another aspect of the invention relates to determining a customer benefit related to the second subset relative to the first subset, assuming the customer chooses the second subset as his service agreement, and how the second subset compares to the first subset. The benefit thereby reflects advantages of any kind including financial gains, reduced spending, improved product lifetime, improved efficiency, increased profit, prolonged maintenance interval, reduced production costs, reduced personnel cost and so on. If the second subset turns out to reflect a less favorable choice compared to the first subset, the determined customer benefit turns “negative” and reflects disadvantages such as increased spending or reduced durability compared to the first subset. All in all, the first and second subsets enable the customer to make a profound decision between the at least two alternatives (i.e. first and second subsets) as the calculated benefit clearly represents a reliable indicator of return-on-investment. So the customer—besides the offer price (service fee)—is provided with another important decision criterion.

Further aspects relate to avoid inconsistency within the subsets. If at least one service option included in a subset turns out to contradict the service requirements, it will be discarded to achieve an accurate service agreement.

Furthermore, if the customer chooses redundant service options which each meet the service requirements but are not necessary in parallel (i.e. one of the chosen options is dispensable), the invention makes provisions for marking and discarding the dispensable option to achieve an accurate service agreement.

Yet another aspect of the invention involves proposing at least two service alternatives to the customer including predefined subsets of service options, meeting the customer's service requirements but not requiring detailed customer data input and selection from a pool of options. Preferably, a benefit of one of the alternatives compared to another/the other alternative is calculated so that the customer has strong indication for an expected return-on-investment and therefore a solid decision making basis. Furthermore, as the alternatives do not require to perform a detailed selection from a service options pool, this embodiment is very convenient for the customer.

A further aspect of the present invention involves a system for preparing a service agreement for a customer using internet technology. A server unit includes an internet page with selectable service options and a calculating device for calculating service fees according to at least two service alternatives chosen by the customer. A business scenario simulator is adapted to calculate a customer benefit as a return-on-investment indicator of one of the chosen alternatives compared to another alternative. The business scenario simulator includes service option related information on for example material wear and tear, personnel costs, production costs, efficiency, lifetime, machine running time, production costs, maintenance interval duration and so on. If the detailed figures for the before mentioned aspects are not exactly known, the business scenario simulator may include approximated values, e.g. derived from general expert knowledge and expert estimation. As the calculated benefit of the invention represents a relative value, imprecise benefit figures involved in the first and second subsets do no great harm as the absolute benefit is not taken into consideration but only the relative benefit of one alternative compared to another.

The business scenario simulator used for calculating the customer benefit can be implemented as a simulation mechanism, which includes a cost/benefit model related to the chosen service options.

In order to provide for a fully automated service agreement preparation, the system uses Internet technology including a server at the provider's side and a terminal having an Internet Browser on the customer's side. The selectable service options are included in internet pages stored in the server's memory and made available to the customer by logging on to the server.

All mechanisms including fee and benefit calculation are implemented as software programs running on the server and the corresponding processing results are displayed on the above mentioned internet pages to the customer.

As soon as the customer has decided on which service options to choose to form his service agreement, the system may also include an agreement generator for generating the finalized agreement document including the chosen service options and the related service fees. This document can be downloaded by the customer, signed and returned to the provider by mail for his signature.

Alternatively, the document can be signed electronically by the provider before downloading by the customer, constituting a “binding offer”. The customer can then sign electronically and send back the agreement document (now forming a binding contract) to the provider, preferably via E-mail.

Further aspects, features and advantages of the present invention will become apparent from the drawings and detailed description of the following preferred embodiments.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 is a flowchart of an exemplary process of the present invention showing an exemplary series of steps of preparing a service agreement for a customer, and

FIG. 2 is a schematic diagram of a computer system adapted to enable an embodiment of the invention.

### DETAILED DESCRIPTION OF THE PREFERRED EMBODIMENT

Overview

The disclosed invention advantageously employs one or more base concepts.

It basically provides an efficient and simple method of preparing a service agreement for a customer operating a technical installation.

The service agreement may include any kind of services, for example regular maintenance, emergency repair, delivery and installation of spare parts, optimization, operation.

One concept is providing a set of selectable service options based on a service requirement.

Another concept involves choosing two service alternatives by selecting corresponding subsets of service options each meeting the service requirement and calculating the related service fees.

Yet another concept provides calculating a relative customer benefit related to a second of the selected subsets compared to a first of the subsets.

Therein the customer benefit includes all kind of advantages the customer gains when choosing the second subset to form his service agreement compared to the first subset, e.g. improvements related to a volume of sale, efficiency of a technical installation, spending on human and non-human resources, profit, return on investment, time saving, customer satisfaction, diversity of product spectrum, reaction time etc.

All the embodiments to be described in more detail in the following can be applied to preparing service agreements for customers operating all kinds of facilities such as industrial plants, hotels, production machinery, turbines, generators, passenger trains, vehicles, home entertainment devices and shall not be limited to any special purpose.

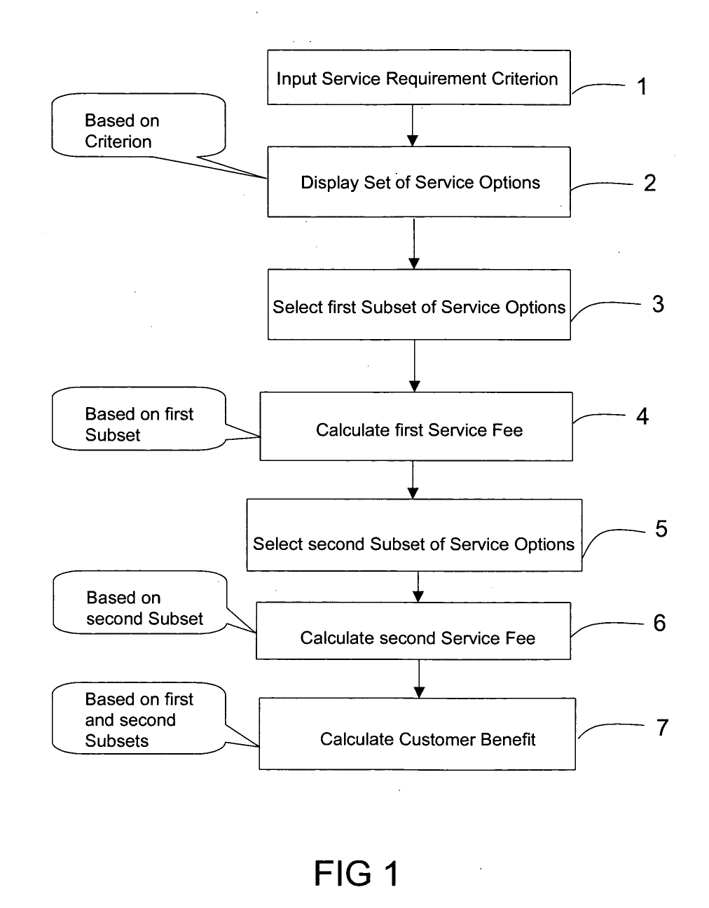

FIG. 1 depicts a flowchart showing a series of exemplary steps that can be performed to monitor a facility according to the invention.

Step 1 involves providing a requirement related to a desired service by a customer. The requirement may include all criterions to be fulfilled by the inquired service agreement: which technological equipment shall be covered, which services shall be performed to that equipment, one-time or regular service etc.

For example, a service “rotor cleaning” represents a criterion. Usually, this criterion implies a plurality of service options to be performed in parallel or subsequently in order to complete rotor cleaning service.

Step 2 depicts providing a set of service options based on the requirement by a service provider. The provided set of service options represents a display of a pre-selected set of service options out of a pool (e.g. database) of service options offered by the service provider. This pre-selection thereby uses the provided requirement as a selection or filter criterion when selecting from the pool/database.

In Step 3, a first subset of service options out of the set of service options is chosen by the customer.

Step 4 depicts calculating a first service fee based on the first subset by the service provider. The first service fee, for example, includes an offer price of the service agreement covering the service options of the first subset (i.e. the first service alternative selected by the customer).

Step 5 and 6 provide choosing a second subset of service options out of the set of service options by the customer and calculating a second service fee based on the second subset by the service provider, respectively.

Finally, step 7 involves calculating a first customer benefit related to the second subset based on the first and second subsets, by the service provider.

As mentioned before, the calculated first benefit is thereby a relative value assuming the customer chooses the second subset as his service agreement, and how the second subset compares to the first subset. As already mentioned, the benefit thereby reflects advantages of any kind including financial gains, reduced spending, improved product lifetime, improved efficiency, increased profit, prolonged maintenance interval, reduced production costs, reduced personnel cost and so on.

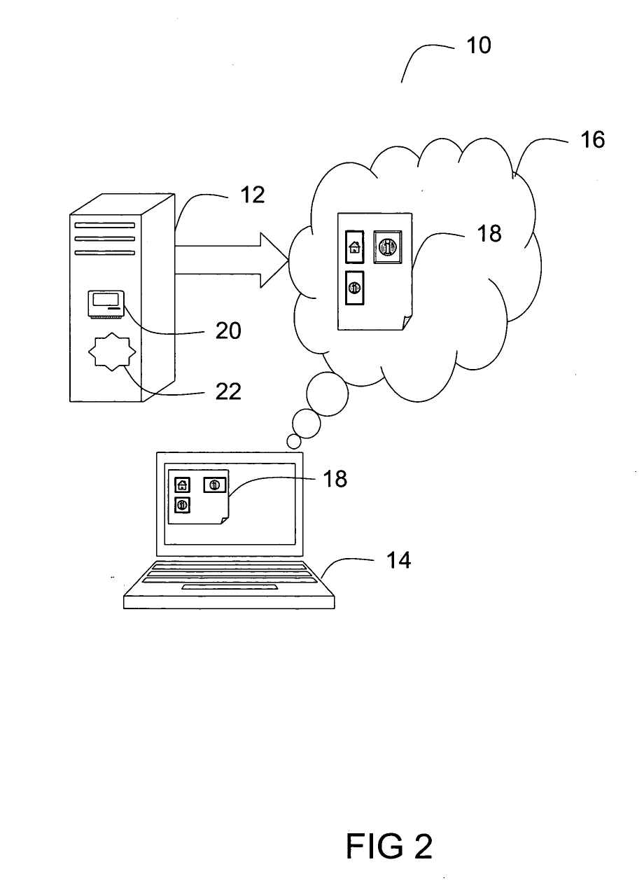

FIG. 2 schematically illustrates a system 10 for preparing a product quote which enables an embodiment of the invention.

The system 10 includes a server 12 for providing a plurality of internet pages 18 to a prospective customer via the Internet 16. The internet pages 18 include a set of service options based on a service requirement criterion input by the customer using a computer terminal 14 logged on to the server 12.

The customer selects at least two subsets of service options representing two alternatives for his desired service agreement.

A processor 20 calculates a service fee for each selected alternative.

Furthermore, a simulator 22 is provided for calculating a relative customer benefit by comparing one of the selected service alternatives to another. The customer benefit is a strong decision making support for the customer enabling him to judge whether for example a more expansive selected second alternative pays off compared to a cheaper first alternative.

The system 10 may include additional features such as an automatic service alternative generator using the input requirement criterion and calculating a further relative benefit based on the generated service alternatives.

Furthermore, the system 10 preferably includes an agreement document generator and means for electronically signing the agreement document by the customer and the service provider.

In addition to the embodiments of the aspects of the present invention described above, those of skill in the art will be able to arrive at a variety of other arrangements and steps which, if not explicitly described in this document, nevertheless embody the principles of the invention and fall within the scope of the appended claims.

For example, the ordering of method steps is not necessarily fixed, but may be capable of being modified without departing from the scope and spirit of the present invention.

What is claimed is:

1. A method of preparing a service agreement, comprising:
providing a requirement related to a desired service by a customer;
providing a set of service options based on the requirement by a service provider;
choosing a first subset of service options out of the set of service options by the customer;
calculating a first service fee based on the first subset by the service provider;
choosing a second subset of service options out of the set of service options by the customer;
calculating a second service fee based on the second subset by the service provider; and
calculating a first customer benefit related to the second subset based on the first and second subsets, by the service provider.

2. The method according to claim 1, wherein the first and second subsets are checked for consistency based on the requirement.

3. The method according to claim 2, wherein non-consistent service options included in the first and second subsets are discarded.

4. The method according to claim 1, wherein the first and second subsets are checked for redundancy based on the requirement.

5. The method according to claim 4, wherein redundant service options included in the first and second subsets are marked.

6. The method according to claim 5, wherein the customer chooses at least one marked service option.

7. The method according to claim 6, wherein the marked service options are discarded.

8. The method according to claim 1, wherein the service provider provides the customer with a first and a second service alternative chosen from the set of service options based on the requirement.

9. The method according to claim 8, wherein a third and a fourth service fee is calculated based on the first and second service alternative respectively.

10. The method according to claim 9, wherein a second customer benefit related to the second service alternative is calculated based on the first and second service alternatives.

11. The method according to claim 1, wherein an internet page including the service options is provided by the service provider.

12. The method according to claim 8, wherein an internet page including the first and second service alternatives is provided by the service provider.

13. The method according to claim 11, wherein the customer chooses the first and second subsets by accessing the internet via a computer terminal having a data input device, calling the internet page and marking the first and second subsets by using the data input device.

14. A system for preparing a service agreement, comprising:
a server unit adapted to be connected to the internet having an internet page including a set of selectable service options;
a first data input mechanism for acquiring a requirement criterion related to a desired service;
a selecting mechanism for selecting a service options portfolio chosen from the set of service options and displaying the service options portfolio based on the requirement criterion;
a second data input mechanism for acquiring a first subset of service options selected from the service options portfolio;
a third data input mechanism for acquiring a second subset of service options selected from the service options portfolio;
a calculating processor for calculating a first and a second service fee based on the first and second subsets respectively; and
a business scenario simulator for calculating a first customer benefit related to the second subset based on the first and second subsets.

15. The system according to claim 14, further comprising a first processing device for checking the first and second subsets for consistency with regard to the requirement criterion.

16. The system according to claim 14, further comprising a second processing device for generating a first and a second recommended service alternative chosen from the service options portfolio.

17. The system according to claim 16, wherein a third and a fourth service fee is calculated based on the first and second recommended service alternatives respectively, by the calculating processor.

18. The system according to claim 16, wherein a second customer benefit is calculated related to the second recommended service alternative based on the first and second recommended service alternatives, by the business scenario simulator.

19. The system according to claim 14, further comprising a computer terminal connected to the server unit via the internet for acquiring customer input data.
